(19) United States
(12) Patent Application Publication
(10) Pub. No.: US 2020/0005246 A1
(43) Pub. Date: Jan. 2, 2020

(54) GOOD TIME TO CALL

(71) Applicant: InterDigital CE Patent Holdings, PARIS (FR)

(72) Inventor: Michael CHRABASZCZ, APTOS, CA (US)

(21) Appl. No.: 16/486,487

(22) PCT Filed: Feb. 14, 2018
(86) PCT No.: PCT/US2018/018258

§ 371 Date: Aug. 15, 2019

(51) Int. Cl. G06Q 10/10; G06Q 30/02; H04W 4/02; H04L 29/08; H04W 4/029

(52) U.S. Cl. CPC G06Q 10/1093; G06Q 30/02; H04W 4/023; H04L 67/306; H04W 4/029; H04W 4/027

(57) ABSTRACT

A method and apparatus are described including determining if a user is at a target location based sensor data, identifying an activity engaged in by the user based on the sensor data, wherein the identification is determined based on one or more databases or a log created by the user, determine a probability that the user is available to be contacted based on whether the identified activity is an uninterruptible activity, initiating contact with the user responsive to the determined probability and providing a notification of the probability indicating whether the user is available at the target location and whether the user is receptive to being contacted.

### FIELD

The proposed method and apparatus relates to the provision of a service that informs a user of the “Presence” and “Receptiveness” of communication with another user.

### BACKGROUND

This section is intended to introduce the reader to various aspects of art, which may be related to the present embodiments that are described below. This discussion is believed to be helpful in providing the reader with background information to facilitate a better understanding of the various aspects of the present disclosure. Accordingly, it should be understood that these statements are to be read in this light.

Many children of elderly parents live a significant distance from their parents, but would like to keep in contact with their parents to ensure that their parents are safe and in good health. Their busy life of career, marriage and their own children make heavy demands on their time. Many of their parents enjoy the contact, but do not wish to initiate contact, since the parents do not want to be a burden, or interrupt their adult children's work. This results in sporadic communications. There is a need for social queues based on behavioral data to indicate when it is a “good time to call”. It should be noted and understood that a “good time to call” includes not only a phone call (which may be on a mobile device or a home telephone), but also texting, IM-ing, chatting, Skyping or Face Timing on a computing device (desktop, laptop, notebook, tablet etc.).

Mobile applications like “WithMe” prompts the child and parent to check in, and confirm with push notifications. But if one or the other is not available, then the originator could become anxious, uncertain of the other's status, waiting for a reply. Further, the expectation of a response to a digital daily notice, as opposed to really wanting to contact them when they are available to talk, lacks sincerity.

It is frustrating to the originator when attempting to contact the recipient. When should they call? It could be a simple problem of, should I call Ms. X at location A now? Yes or no? But the scope can be expanded to be more dynamic—try location B in an hour. And the scope of the results can be more than a binary—what is the likelihood that the person is available, and what is the likelihood that the other person wants to communicate?

### SUMMARY

The proposed method and apparatus collects current status information from a set of sensors and from a predictive model that generates two values—Presence and Receptiveness.

The proposed method and apparatus will be described in terms of elderly (senior) parents who are retired and spend a greater amount of time homebound as opposed to their working age children who, because they are working, are home a lesser amount of time. While the invention is principally directed to the elderly (seniors, parents), it may also be used for any other restrictive situations such as house arrest situations or boarding school situations or the like.

Home automations systems for seniors will continue to grow in sophistication with the ability to identify behavior and presence within the senior's home. The proposed method and apparatus provides a multiple sensor approach. Simple motion sensors can detect human activity.

What is additionally helpful is a set of audio sensors with a machine learning backend. Data detection and collection are used to identify the audio signature of a device. The audio signature of a device is used to infer or further define the type of activity. The proposed method and apparatus discerns if the senior was listening to music, to the radio, or watching television. The proposed method and apparatus identifies appliances that could indicate if the senior was preparing food in the kitchen, cleaning the house, or using the washroom. Audio sensing could also detect common motions such as footsteps providing additional activity data.

In addition to the audio and motion sensing, the proposed method and apparatus is able to couple these indicators with social sensors, for example, when the seniors are on a computer and connected to a social network like Facebook. By aggregating this current behavioral data and sensor (audio, motion and digital/behavioral) data and cross referencing the aggregated behavioral data and audio and motion sensor data to historical behavioral and audio and motion sensor data, one can determine (provide, calculate) a likelihood (percentage of success) that the parent(s) (or at least one of the parents) is present in the home and is receptive to a phone call (or Skype call or Face Time call or texting). This can be communicated to other interested parties. For example, the parent's mobile application (app) could request this from a service provided by the proposed method and apparatus: there is a 90% chance that your father/mother is at home. Further, the data can be analyzed for trends in behavior to discover the appropriateness of the timing of making contact—It is a 10% chance of it being a “good time to call”, your father/mother is watching his/her favorite soap opera. Therefore, there are two data points that the system provides—presence and receptiveness. These solutions can be ported into other applications for making contact (e.g., Skype and Face Time). Prior to making a call (making contact), the screen can flash red—this is not a good time. This is the case where the child is initiating the call. Another application can be developed to send notifications to the adult child when it's a “good time to call” their parents. The recommendation to contact can be reversed too, to provide a signal regarding when it's a good time to contact an adult child, for example, Mike is waiting in the airport for his flight.

A method and apparatus are described including determining if a user is at a target location based sensor data, identifying an activity engaged in by the user based on the sensor data, wherein the identification is determined based on one or more databases or a log created by the user, determine a probability that the user is available to be contacted based on whether the identified activity is an uninterruptible activity, initiating contact with the user responsive to the determined probability and providing a notification of the probability indicating whether the user is available at the target location and whether the user is receptive to being contacted.

### BRIEF DESCRIPTION OF THE DRAWINGS

The proposed method and apparatus is best understood from the following detailed description when read in conjunction with the accompanying drawings. The drawings include the following figures briefly described below:

FIG. 1 is a schematic diagram illustrating the operation of an exemplary embodiment of the proposed method.

FIG. 2 is a high level block diagram of an exemplary embodiment of the proposed method and apparatus.

FIG. 3 is a flowchart of an exemplary embodiment of the proposed method.

FIG. 4 is a flowchart of a portion of an exemplary embodiment of the proposed method.

FIG. 5 is a flowchart of a portion of an exemplary embodiment of the proposed method.

It should be understood that the drawing(s) are for purposes of illustrating the concepts of the disclosure and is not necessarily the only possible configuration for illustrating the disclosure.

### DETAILED DESCRIPTION

The present description illustrates the principles of the present disclosure. It will thus be appreciated that those skilled in the art will be able to devise various arrangements that, although not explicitly described or shown herein, embody the principles of the disclosure and are included within its scope.

All examples and conditional language recited herein are intended for educational purposes to aid the reader in understanding the principles of the disclosure and the concepts contributed by the inventor to furthering the art, and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative circuitry embodying the principles of the disclosure. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, read only memory (ROM) for storing software, random access memory (RAM), and nonvolatile storage.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The disclosure as defined by such claims resides in the fact that the functionalities provided by the various recited means are combined and brought together in the manner which the claims call for. It is thus regarded that any means that can provide those functionalities are equivalent to those shown herein.

There are three sets of sensors in the sensing system of the proposed method and apparatus: motion, sound and digital (social, behavioral). A set of physical sensor devices are placed in the home to detect presence and location. Data is collected from at least one or more of audio sensors, motion sensors and social sensors. For example, motion sensor data is collected and stored. Data is stored locally or optionally may be uploaded to a server on the internet (or a cloud service) that is storing the data. Periodically, the system will execute a set of rules on the data to determine behaviors candidates: it appears your father/mother is having lunch, it appears your father/mother is watching TV, etc.

Audio detection sensors collect audio data for activity identification. It appears your father/mother is watching TV in the living room and it's his/her favorite Soap Opera. The proposed method and apparatus detects audio from appliances like a kettle. He/she is making tea, to watch his/her favorite show. The audio sensors detect and identify what type of activity the person (user, subscriber) might be engaged in. The audio sensor portion of the sensing system may benefit from a machine learning background. This may be accomplished in part by the user (subscriber) providing a list of the make and models of the appliances they own and use. For example, the user (subscriber) might have a blender, mixer, dish washer, food processor etc. By providing the make and model of the various appliances, it may be possible to obtain acoustic (audio) signatures of the various appliances owned and used by the subscriber (user) from the various manufacturers or a database of various acoustic (audio) signatures may be available online. Of course, this may not cover the tea kettle boiling water or the audio of his/her favorite TV show (program) but may cover a large portion of the appliances. It should also be noted that the above identified appliances are generally associated with chores and thus, generally not considered as interruptible. A tea kettle boiling, however, is probably something and at a time that is generally considered as interruptible and, therefore, a “good time to call”.

Detection by the sensors of the operation of certain appliances and/or other situations may indicate that the user is engaged in an activity deemed to be uninterruptible. This may be achieved, for example, by determining from the sensors as to which devices are in operation For example if the system detects that a vacuum cleaner is in operation then it could be determined that this is not a “good time to call”. In the case of the detection of a hair dryer in operation, for example it may be deemed that it is not a “good time to call”. This may also be the case if the sensors detect water running in either the bathroom or kitchen. If the sensors detect that the TV is on and based on the machine learning, it can be determined that the user's favorite program (show) is on, then similarly, it is probably a “good time to call”. Uninterruptible activities may vary for each user. Sensor detection of water running in the bathroom or kitchen may be deemed universally to be not a “good time to call”. Activities deemed to be uninterruptible may be selected, for example by selecting the appliances whose operation may be classified as the user being engaged in an uninterruptible activity. The sensing system also provides social (digital, behavioral) sensors from computing devices and mobile devices as well as TV related data provided by a set top box (STB), home gateway or a router. He/she was on Facebook, but stopped, as his/her show as starting. His/her mobile phone was the last device used in the collection of communication devices he/she owns, so that would be the likely contact device to reach him/her at/on. And since the GPS detects that it's in his/her apartment, where he/she is making tea, to watch his/her favorite show, it would be the best place to reach him/her. Since you do not wish to disturb your father's/mother's favorite TV show (program), your applications can schedule the call back when it's a “good time to call”, and ensure that the conditions are better and make the call (make contact) then. The proposed method and apparatus may include two phases—a learning/training and an active phase. The machine learning/training phase is optional but would provide better results from the onset of use. The learning/training phase is perhaps two weeks long to enable collection and analysis of data to be preserved and stored for use as historical data upon which to base “good time to call” decisions in the active phase. In the active phase new data are observed (and recorded) and analyzed (compared to historical data) to determine if the person is engaged in an activity meaningful to them (bathroom, food prep, favorite TV show) or might be receptive to a phone call (contact) and based on the analysis determine/calculate a probability (likelihood) that it is a “good time to call”. Based on the sensors and machine learning, activities that are meaningful to the user are identified. If the identified activities are meaningful then they are probably uninterruptible activities as described above.

A result of phase two is a notification to an adult child (or grandchild) that it is a good time to call the person. It would also be possible for the child to invoke an application (app) if they are free to determine if it is a “good time to call” before the child actually initiates a call. It may be possible via yet another application (app) for the child to advise the application (app) that they are free and to notify the person that now is a “good time to call” (waiting for a flight). It should be noted that the child side does not operate using sensors but enters their availability into an application (app).

The proposed method and apparatus provides a service that informs a user (originator, transmitting user) of the “Presence” and “Receptiveness” of communication with another user. Presence is a percent from 0% to 100% that indicates the probability (likelihood) that the user (recipient, receiving user) is present at the target location. The originator's request can specify multiple locations. Receptiveness is a percentage grade from 0% to 100% that the user is likely to engage in the specific type of communication transaction. Communication transaction types are defined in a finite list, and are present as part of the request. A user may be present, but preoccupied or incapable of the interaction (communication). Conversely, a user may be receptive, but is currently not present in that particular target location. The proposed method and apparatus is useful as preamble to making a request for communications and can be integrated as a filter to requests.

The service provided by the proposed method and apparatus can be used by applications that perform an appropriate action based upon the results from the proposed method and apparatus. For example, a request to the service provided by the proposed method and apparatus could be made prior to a phone call, a text message, or a video call transmission. If the likelihood (probability) is greater than a threshold that the recipient will be present, and receptive to the communication, the interaction is initiated. If it is not a “good time to call”, a better time could be determined and a call mechanism could be established to notify the originator when the recipient is ready for the contact (communication). In another case, it may be that the communication medium is not favorable—the recipient may be watching TV but the recipient (receiving user) is still receptive to a text message. The message could be to redirect the originator (transmitting user) to a better medium. If the user is receptive, but not present, an option to locate the most probable alternate device or location could be used to track, find and engage the recipient (receiving user) in a form of communication.

The request contains the following:
RECIPIENT—the user with whom the originator wishes to communicate.
COMMUNICATION_TYPE—the type of message that will be sent (transmitted, forwarded) and the communication medium that the originator (transmitting user) would prefer to use.
TARGET_LOCATION—a uniquely identifiable location for the communication to take place. The proposed method and apparatus uses the target location to locate the destination (recipient's location).

TIME—when the originator (transmitting user) wishes to initiate communication. The proposed method and apparatus can also determine if a future time would be a better time to call.

It should be noted that the service provided by the proposed method and apparatus does not initiate or facilitate the communication. It is a separate method and apparatus that a communication flow can utilize to improve communications. In order to calculate the Presence and Receptiveness values, the system leverages a set of subsystem that provide the data:

The supporting subsystems can include one or more of the following:
1) Sensor Subsystem—collects and aggregates all types of sensor data for processing. Typically, the collecting (gathering) of the sensor data is local but the data could be uploaded to a server or a cloud service for aggregation and backend processing (analysis) is performed.
   a. Motion
      The facility can be installed with motion sensors that can track where and when the last movement was made in the target location. Detect movement and location in the location (residence, quarters).
   b. Audio
      Based on the audible sounds, behaviors can be identified such as walking, using appliances, watching TV or listening to music.
   c. Social (digital, behavioral)
      Accessing the Internet creates indicators that person may be at a specific location, and may be receptive. When I see a green dot on Facebook, I know my mother is at home, in her den surfing the Internet.
2) Machine Learning Subsystem—Prediction based on time and historical data. Historical data are collected and stored (recorded) and used to create a model for machine learning. Collected presence and receptiveness grades can be archived and trends identified to provide a prediction based on time. A stream of active (live) data is supplied to the machine learning engine to create inferences on Presence and

Receptivity to better predict the likelihood (probability) of successfully initiating communication.
3) Request Handler Subsystem—The Request Handler subsystem is a mechanism that collects, stores, calculates, and processes request on the behavior of the occupant (recipient, receiving user) based on the aggregated data from the sensors. The Request Handler subsystem provides a response to the request can be used by applications regarding the PRESENCE and the RECEPTIVITY of the occupant (recipient, receiving user).
   a. Request
      A request is made by an originator (transmitting user) that only wants to communicate when the recipient (receiving user) is both present at the target location and receptive to communicating.
   b. Calculate
      Each value is a calculated value using the current sensor data and historical data. A feedback mechanism to report false positives tunes the formula with the intent of increasing the prediction (probability, likelihood) accuracy.
   c. Make Recommendation
      When an unfavorable result is determined (calculated), the system can also provide feedback to the requestor (originator, transmitting user) such as a recommendation which could be a custom message that helps to inform the requestor (originator, transmitting user) as to the reason the results are so low.

Some examples of requests and responses follows:

request (PRESENCE)->[SERVICE]->response={@home|away}+{reason}

For example, request (PRESENCE)->[SERVICE@MIKEC HOME]->away+no motion sensor in 48 hours.

request (RECEPTIVITY)->[SERVICE]->response={% likely to reach}+{reason}+{best device to contact}

For example, request (RECEPTIVITY)->[SERVICE@MIKEC HOME]->24%+TV interaction 2 minute ago+iPhone in the living room, last device used 20 minutes ago.

request (WHEN GOOD, DO THIS)—the service registers the request and performs the call back action “DO THIS” when the threshold associated with “good” is met.

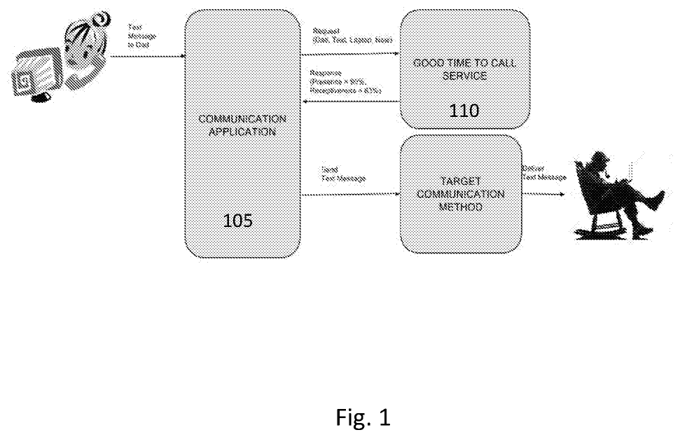

FIG. 1 is a schematic diagram illustrating the operation of an exemplary embodiment of the proposed method. The originator (transmitting user) desires to send (transmit) a text message to her dad. She initiates communication through a communication application 105 that uses the proposed “good time to call” service 110, which is tangibly embodied in a gateway type device such as a home gateway, a set top box, a router, a bridge, a brouter or any equivalent device. The communication application 105 transmits a request message to the proposed “good time to call” service 110 including who the originator (transmitting user) wants to contact (her dad), the type of contact the originator wants to make (text), the communication medium (laptop) the originator wants to use, and when the originator wants to make contact (now). It should be noted that “who” may also be the target location or the target location may be an additional parameter in the request message. The use of the target location as a parameter depends upon whether there are multiple locations where the recipient (receiving user) is or can be found. The proposed “good time to call” service 110 responds to the communication application with an indication of the “Presence” of the recipient (receiving user) at the target location. The response also provides an indication of the “Receptivity” of the recipient (receiving user) to making contact at the target location. Both the “Presence” and the “Receptivity” are indicated as a percentage which is a probability or likelihood of the recipient's (receiving user's) presence and receptivity to contact at the target location. Once the communication application 105 receives the response, if the probabilities are above threshold values, contact may be initiated. For example, as shown on FIG. 1 sending a text message to the originators dad. The threshold value may be different for “Presence” and for “Receptivity” and may be different for each contact that the originator (transmitting user) has.

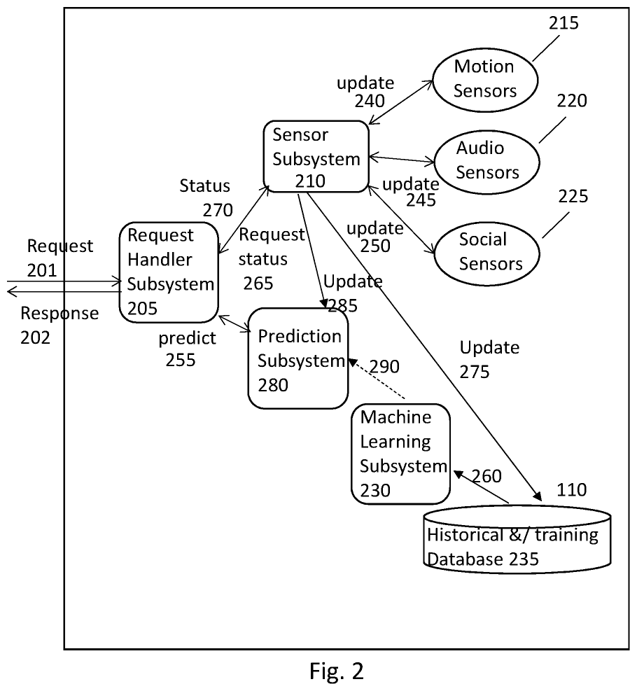

FIG. 2 is a high level block diagram of an exemplary embodiment of the proposed method and apparatus. The proposed “good time to call” service 110, which is tangibly embodied in a gateway type device or optionally may reside in a server or a cloud service, either or both of which have at least one processor. The following description assumes that the proposed method and apparatus is tangibly embodied in a gateway type device. A request 201 is received by the proposed “good time to call” service (from the communication application 105) and is routed to the request handler subsystem 205. The Request Handler Subsystem includes at least one processor. The at least one processor of the request handler subsystem 205 is configured to access the sensor subsystem 210 to retrieve the latest sensor data by requesting status 265 from the sensor subsystem. The sensor subsystem includes at least one processor. The at least one processor of the sensor subsystem 210 is configured to access the motion sensors 215, the audio sensors 220 and the social sensors 225. The various sensors automatically update the sensor subsystem on a regular basis but are also accessed when the proposed “good time to call” service is initiated by a communication application to retrieve the latest data in order to make the best calculation of the “Presence” and “Receptivity” of the recipient (receiving user) is to making contact with the originator (transmitting user). The updates and/or access of the sensors is accomplished via the bi-directional update 240 flow to/from the motion sensors, the bi-directional update 245 flow to/from the audio sensors and the bi-directional update 250 flow to/from the social sensors. The sensors (215, 220, 225) continually collect sensor data and update the sensor subsystem with the collected sensor data. The sensor subsystem 210 is also configured to periodically update the historical and/or training database 235 in memory (storage, a database) with the collected sensor data as the sensor data ages via update flow 275. The sensor subsystem 210 is configured to respond to the request handler subsystem 205 with a status message 270 providing the request handler subsystem 205 with the latest sensor data available for the recipient (receiving user). The historical and/or training data may include training data depending upon whether the recipient participated in a learning (training) phase. The training (learning) phase is an optional phase but participation in the training phase provides better results from the onset of active use of the proposed “good time to call” service. Machine learning (training) subsystem 230 can learn about the recipient's (receiving user's) by analyzing historical sensor data and, if available, training data. The machine learning subsystem includes at least one processor. The prediction subsystem 280 receives updates from the sensor subsystem via update flow 285. The prediction subsystem 280 is configured to be executed to calculate (determine) “Presence” and “Receptivity” of the recipient (receiving user). The request handler subsystem 205 is configured to receive a prediction of the recipient's (receiving user's) “Presence” and “Receptivity” from the prediction subsystem. The prediction subsystem 280 bases its prediction on the updated (most recent) sensor data received from the sensor subsystem 210 via update flow 285 and optionally and the historical and/or training database 235 that the machine learning subsystem 230 has received and forwarded to the machine learning subsystem 230 via 260. Ultimately, the request handler subsystem 205 is configured to provide a response to the communication application 105 in the form of a prediction of the recipient's (receiving user's) “Presence” and “Receptivity”. The proposed “good time to call” service 110 responds to the communication application 105 with an indication of the “Presence” of the recipient (receiving user) at the target location. The response also provides an indication of the “Receptivity” of the recipient (receiving user) to making contact at the target location. Both the “Presence” and the “Receptivity” are indicated as a percentage which is a probability or likelihood of the recipient's (receiving user's) presence and receptivity to contact at the target location. Once the communication application 105 receives the response, if the probabilities are above threshold values, contact may be initiated. For example, as shown on FIG. 1 sending a text message to the originators dad. The threshold value may be different for “Presence” and for “Receptivity” and may be different for each contact that the originator (transmitting user) has. The action taken by the application is independent of the system and can be configured based on desired operation, and can be dynamically changed. The system, thus, provides two data points.

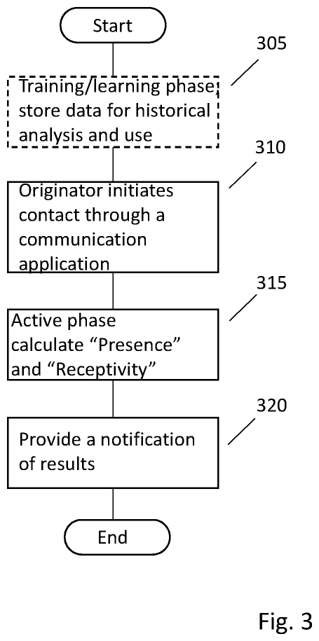

FIG. 3 is a flowchart of an exemplary embodiment of the proposed method. The optional training/learning phase shown as a rectangle (process block) outlined in dotted lines. The dotted lines indicate that the process is optional. At 305 the optional training/learning phase uses data collected about the activities of a recipient (receiving user) over a period of time. The collected data may be from any of the motion sensors, the audio sensors or the social sensors or all of the sensors and sensor types. The period of time may vary among various recipients (receiving users) but, for example, the period of time may be two weeks. Based on the analysis of the collected data of the recipient (receiving user) the service identify and classify activities performed by the recipient (receiving user). The collected data is also stored in memory (storage, a database) for use and retention as historical data of the activities of the recipient (receiving user). At 310, a call (contact) originator initiates contact with the recipient through communication application 105. Communication application 105 forwards a request 201 to the proposed “good time to call” service 110, which calculates (determines) “Presence” and “Receptivity” of the recipient (receiving user) to contact by the call (contact) originator. The request 201 is received by request handler subsystem 205. At 315 the active phase, which includes the calculation (determination) of the “Presence” and “Receptivity” of the recipient (receiving user) to contact by the call (contact) originator. At 320 the proposed “good time to call” service in the gateway type device provides a notification of the “Presence” and “Receptivity” of the recipient (receiving user) to contact by the originator.

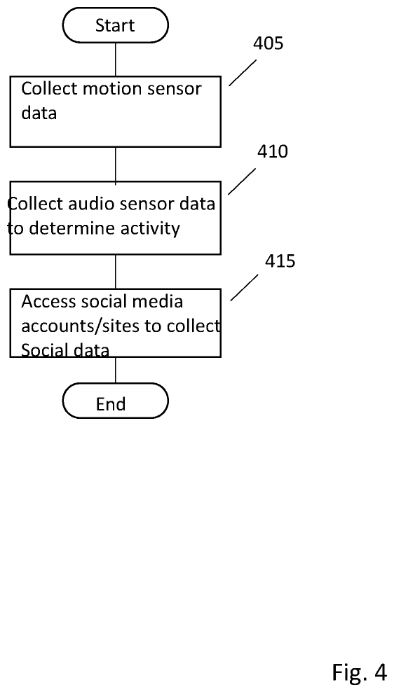

FIG. 4 is a flowchart of an exemplary embodiment of the proposed method. FIG. 4 is executed any number of times. For example, the operations (processes) of FIG. 4 could be executed during training/learning phase 305. The operations (processes) of FIG. 4 are, importantly, executed on a periodic and ongoing basis to collect and store recipient (receiving user) data to know at almost all times what the recipient is doing (what activities the recipient is engaged in and if they are at a target location, which may be home or elsewhere). The operations (processes) of FIG. 4 may, importantly, be executed when the active phase 315 proposed “good time to call” service is attempting to calculate (determine) the “Presence” and “Receptivity” and finds that it does not have enough current sensor data to perform the calculation (determination). In that event the operations (processes) of FIG. 4 are executed to obtain additional current sensor data of the recipient (receiving user). At 405 motion sensor data is collected. At 410 audio sensor data is collected. Both motion sensor data and audio sensor data are used to help determine the “Presence” of the recipient (receiving user) at a target location. At 415 social media accounts (sites) are accessed by the proposed “good time to call” service of the gateway type device to collect social data, which is used to determine if the recipient (receiving user) is active on one or more social media accounts (sites).

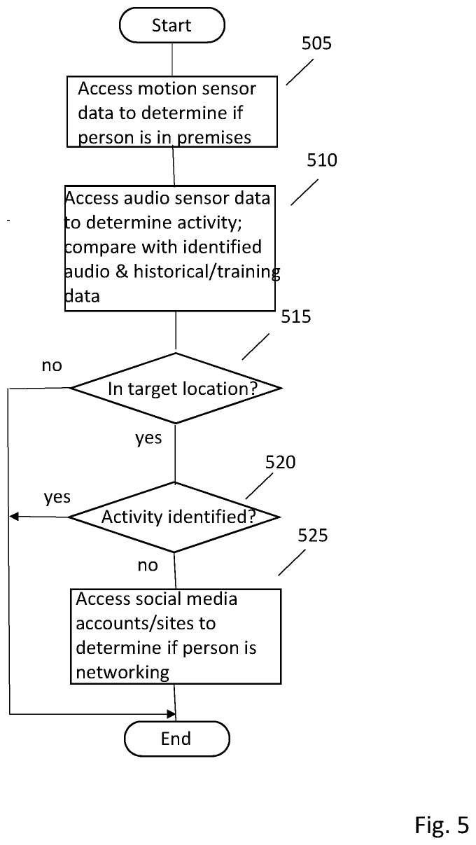

FIG. 5 is a flowchart of a portion of an exemplary embodiment of the proposed method. The request handler subsystem 205 accesses the sensor subsystem 210 to retrieve the latest sensor data by requesting status 265 from the sensor subsystem. At 505, the sensor subsystem 210 accesses the motion sensors 215 to help determine if the recipient (receiving user) is at the target location, which may be the recipient's (receiving user's) premises or may be somewhere else. At 510, the sensor subsystem accesses the audio sensors 220 to help determine what activity the recipient (receiving user) might be engaged in. The audio data is compared with identified audio and historical and/or training (learning) data. The data collected and used by the proposed “good time to call” service may thus be stored (recorded) in a server or in a cloud service. At 515 a test is performed to determine if it could be determined if the recipient (receiving user) is at the target location. If the recipient (receiving user) is at the target location specified in the request 201, then at 520 a test is performed to determine if the activity could be identified. If the activity was not able to be identified then at 525 the social sensors 225 are accessed to determine if the recipient (receiving user) is accessing social media accounts (sites). If the activity could be identified, it is assumed that the activity is something in the target location such as washing dishes. It is assumed that if the activity could thus be identified then the recipient is probably not simultaneously accessing social media accounts (sites) so processing proceeds to the end of the process. If at 515, it was able to be determined that the recipient (receiving user) is not at the target location then the process proceeds to the end.

It is to be understood that the proposed method and apparatus may be implemented in various forms of hardware, software, firmware, special purpose processors, or a combination thereof. Special purpose processors may include application specific integrated circuits (ASICs), reduced instruction set computers (RISCs) and/or field programmable gate arrays (FPGAs). Preferably, the proposed method and apparatus is implemented as a combination of hardware and software. Moreover, the software is preferably implemented as an application program tangibly embodied on a program storage device. The application program may be uploaded to, and executed by, a machine comprising any suitable architecture. Preferably, the machine is implemented on a computer platform having hardware such as one or more central processing units (CPU), a random access memory (RAM), and input/output (I/O) interface(s). The computer platform also includes an operating system and microinstruction code. The various processes and functions described herein may either be part of the microinstruction code or part of the application program (or a combination thereof), which is executed via the operating system. In addition, various other peripheral devices may be connected to the computer platform such as an additional data storage device and a printing device.

It should be understood that the elements shown in the figures may be implemented in various forms of hardware, software or combinations thereof. Preferably, these elements are implemented in a combination of hardware and software on one or more appropriately programmed general-purpose devices, which may include a processor, memory and input/output interfaces. Herein, the phrase “coupled” is defined to mean directly connected to or indirectly connected with through one or more intermediate components. Such intermediate components may include both hardware and software based components.

It is to be further understood that, because some of the constituent system components and method steps depicted in the accompanying figures are preferably implemented in software, the actual connections between the system components (or the process steps) may differ depending upon the manner in which the proposed method and apparatus is programmed. Given the teachings herein, one of ordinary skill in the related art will be able to contemplate these and similar implementations or configurations of the proposed method and apparatus.

For purposes of this application and the claims, using the exemplary phrase “at least one of A, B and C,” the phrase means “only A, or only B, or only C, or any combination of A, B and C.”

1. A method, said method comprising:
determining if a user is at a target location based on sensor data;
identifying an activity engaged in by said user based on said sensor data;
determining a metric that said user is available to be contacted based on whether the identified activity is determined to be an interruptible activity; and
initiating contact with said user responsive to said determined metric.

2. The method according to claim 1, further comprising providing a notification of said probability indicating whether said user is available at said target location and whether said user is receptive to being contacted.

3. The method according to claim 1, further comprising collecting sensor data, wherein sensor data includes at least one of motion sensor data, audio sensor data social data, wherein said social data is collected by accessing social networking sites.

4. The method according to claim 1, further comprising receiving a request for contacting said user, wherein said request for contacting said user includes at least one of an identity of the user, a preferred communication medium, said target location and a preferred time for the contact.

5. The method according to claim 1, further comprising storing said sensor data.

6. The method according to claim 1, further comprising initiating contact with said user if the probability that the user is available at said target location is greater than a first threshold and the probability that said user is receptive to being contacted is greater than a second threshold.

7. The method according to claim 1, further comprising continually collecting sensor data and updating a database with the collected sensor data and periodically updating historical and/or training data with the collected sensor data as the sensor data ages.

8. An apparatus, comprising:
at least one processor configured to:
determine if a user is at a target location based on sensor data;
identify an activity engaged in by said user based on said sensor data;
determine a metric that said user is available to be contacted based on whether the identified activity is determined to be an interruptible activity; and
initiate contact with said user responsive to said determined metric.

9. The apparatus according to claim 8 further configured to provide a notification of said metric indicating whether said user is available at said target location and whether said user is receptive to being contacted.

10. The apparatus according to claim 8, further configured to collect sensor data, wherein sensor data includes at least one of motion sensor data, audio sensor data social data, wherein said social data is collected by accessing social networking sites.

11. The apparatus according to claim 8, further configured to receive a request for contacting said user, wherein said request for contacting said user includes identity of the user, a preferred communication medium, said target location and a preferred time for the contact.

12. The apparatus according to claim 8, further configured to store said sensor data.

13. The apparatus according to claim 9, wherein said notification further comprises an indication of whether the metric that the user is available at said target location is greater than a first threshold and the metric that said user is receptive to being contacted is greater than a second threshold.

14. The apparatus according to claim 8, further configured to continually collect sensor data and update a database with the collected sensor data and periodically update historical and/or training data with the collected sensor data as the sensor data ages.

15. An apparatus, comprising:
means for determining if a user is at a target location based on sensor data;
means for identifying an activity engaged in by said user based on said sensor data;
means for determining a metric that said user is available to be contacted based on whether the identified activity is determined to be an interruptible activity; and
means for initiating contact with said user responsive to said determined metric.

16. The apparatus of claim 15, further comprising means for providing a notification of said metric indicating whether said user is available at said target location and whether said user is receptive to being contacted.

17. The apparatus according to claim 15, further comprising means for collecting sensor data, wherein sensor data includes at least one of motion sensor data, audio sensor data social data, wherein said social data is collected by accessing social networking sites.

18. The apparatus according to claim 15, further comprising means for receiving a request for contacting said user, wherein said request for contacting said user includes identity of the user, a preferred communication medium, said target location and a preferred time for the contact.

19. The apparatus according to claim 15, further comprising means for storing said sensor data.

20. The apparatus according to claim 15, further comprising means for initiating contact with said user if the probability that the user is available at said target location is greater than a first threshold and the probability that said user is receptive to being contacted is greater than a second threshold.

21. The apparatus according to claim 15, further comprising means for continually collecting sensor data and updating a database with the collected sensor data and periodically updating historical and/or training data with the collected sensor data as the sensor data ages.
